(19) United States
(12) Patent Application Publication
(10) Pub. No.: US 2026/0370820 A1
(43) Pub. Date: Nov. 19, 2026

(54) METHOD AND DEVICE FOR VIDEO ENCODING/DECODING USING GEOMETRIC PARTITIONING MODE

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Sea Nae Park, Uijeongbu-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/135,535

(22) PCT Filed: Dec. 5, 2023
(86) PCT No.: PCT/KR2023/019868

§ 371 Date: Jun. 4, 2025

(30) Foreign Application Priority Data
Dec. 6, 2022 (KR) 10-2022-0168738
Dec. 1, 2023 (KR) 10-2023-0172358

(51) Int. Cl. H04N 19/119; H04N 19/105; H04N 19/176; H04N 19/52

(52) U.S. Cl. CPC H04N 19/119; H04N 19/105; H04N 19/176; H04N 19/52

(57) ABSTRACT

The present disclosure discloses video encoding/decoding methods and apparatus and provides in at least one embodiment a video decoding method including determining a motion vector of a first region of a current block, determining a motion vector of a second region of the current block, determining partitioning direction candidates by using the template blocks of the current block and determining partitioning direction information among the partitioning direction candidates, generating a prediction block of the first region and generating a prediction block of the second region, determining a blending area by using the partitioning direction information and determining a blending matrix by using the blending area, and generating a prediction block of the current block by using the blending matrix, the prediction block of the first region, and the prediction block of the second region.

### TECHNICAL FIELD

The present disclosure in some embodiments relates to methods and apparatus for encoding and decoding by using a geometric partitioning mode. More particularly, the present disclosure relates to video encoding/decoding methods and apparatus for determining motion vectors of two partitioned regions in a geometric partitioning mode, determining a geometric partitioning mode, and determining a blending area, thereby generating a prediction block of the current block.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The geometric partitioning mode is a method of generating a prediction block of the current block by weighted averaging two inter-predicted signals generated by dividing a coding unit (CU) into two regions and performing inter prediction independently in the two regions. When generating the prediction block of the current block by using the geometric partitioning mode, there is a need to increase the encoding/decoding efficiency.

### DISCLOSURE

### Technical Problem

The present disclosure in some embodiments seeks to provide methods and apparatus for determining motion vectors of the respective regions by performing template matching in a geometric partitioning mode.

The present disclosure further seeks to provide methods and apparatus for determining partitioning direction information by performing template matching in the geometric partitioning mode.

The present disclosure further seeks to provide methods and apparatus for generating a final prediction block of the current block by weighted averaging the prediction blocks of the respective regions by using a blending matrix.

The present disclosure further seeks to provide methods and apparatus for increasing video encoding/decoding efficiency.

The present disclosure further seeks to provide a recording medium storing a bitstream generated by video encoding/decoding methods or apparatus of the present disclosure.

The present disclosure further seeks to provide a method and apparatus for transmitting the bitstream generated by the video encoding/decoding methods or apparatus of the present disclosure.

### SUMMARY

The present disclosure in at least one embodiment provides a video decoding method that may include determining a motion vector of a first region of a current block by using a merge candidate list, determining a motion vector of a second region of the current block by using the motion vector of the first region and template blocks of the current block, determining partitioning direction candidates by using the template blocks of the current block and determining partitioning direction information of the current block among the partitioning direction candidates, generating a prediction block of the first region by using the motion vector of the first region and generating a prediction block of the second region by using the motion vector of the second region, determining a blending area by using the partitioning direction information and determining a blending matrix by using the blending area, and generating a prediction block of the current block by using the blending matrix, the prediction block of the first region, and the prediction block of the second region.

The present disclosure in another embodiment provides a video encoding method that may include determining a motion vector of a first region of a current block by using a merge candidate list, determining a motion vector of a second region of the current block by using the motion vector of the first region and template blocks of the current block, determining partitioning direction candidates by using the template blocks of the current block and determining partitioning direction information of the current block among the partitioning direction candidates, generating a prediction block of the first region by using the motion vector of the first region and generating a prediction block of the second region by using the motion vector of the second region, determining a blending area by using the partitioning direction information and determining a blending matrix by using the blending area, and generating a prediction block of the current block by using the blending matrix, the prediction block of the first region, and the prediction block of the second region.

Further, the present disclosure provides a method of transmitting a bitstream generated by the video encoding methods or apparatus according to the present disclosure.

Further, the present disclosure may provide a recording medium storing a bitstream generated by the video encoding methods or apparatus according to the present disclosure.

Further, the present disclosure may provide a recording medium storing a bitstream that is received, decoded, and utilized to reconstruct a video by the video decoding apparatus according to the present disclosure.

### Advantageous Effects

The present disclosure can provide methods and apparatus for determining the motion vectors of the respective regions by performing template matching in the geometric partitioning mode.

Further, the present disclosure can provide methods and apparatus for determining partitioning direction information by performing template matching in the geometric partitioning mode.

Further, the present disclosure can provide methods and apparatus for generating a final prediction block of the current block by weighted averaging the prediction blocks of the respective regions by using a blending matrix.

Further, the present disclosure can provide methods and apparatus for increasing video encoding/decoding efficiency.

Effects obtainable with the present disclosure are not limited to the above-mentioned effects, and other unmentioned effects could be clearly understood by those skilled in the art from the description below.

### BRIEF DESCRIPTION OF THE DRAWINGS

FIG. 1 is a block diagram of a video encoding apparatus that may implement the techniques of the present disclosure.

FIG. 2 illustrates a method for splitting a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram of a method of applying a geometric partitioning mode to a 32×32 block, according to at least one embodiment of the present disclosure.

FIGS. 7A and 7B are diagrams illustrating angular parameters and distance parameters in a geometric partitioning mode, according to at least one embodiment of the present disclosure.

FIG. 8 is a diagram illustrating a look-up table of partitioning direction information in a geometric partitioning mode, according to at least one embodiment of the present disclosure.

FIG. 9 is a diagram illustrating a geometric partitioning boundary and two subregions within the current block in a geometric partitioning mode, according to at least one embodiment of the present disclosure.

FIG. 10 is a flowchart of a process for generating a prediction block of the current block by using the geometric partitioning mode, according to at least one embodiment of the present disclosure.

FIG. 11 is a diagram illustrating a current block and template blocks neighboring the current block, according to at least one embodiment of the present disclosure.

FIG. 12 is a diagram illustrating a method of performing template matching, according to at least one embodiment of the present disclosure.

FIG. 13 is a diagram illustrating a method of determining partitioning direction information by performing template matching, according to at least one embodiment of the present disclosure.

FIG. 14 is a flowchart of a video decoding process according to at least one embodiment of the present disclosure.

FIG. 15 is a flowchart of a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

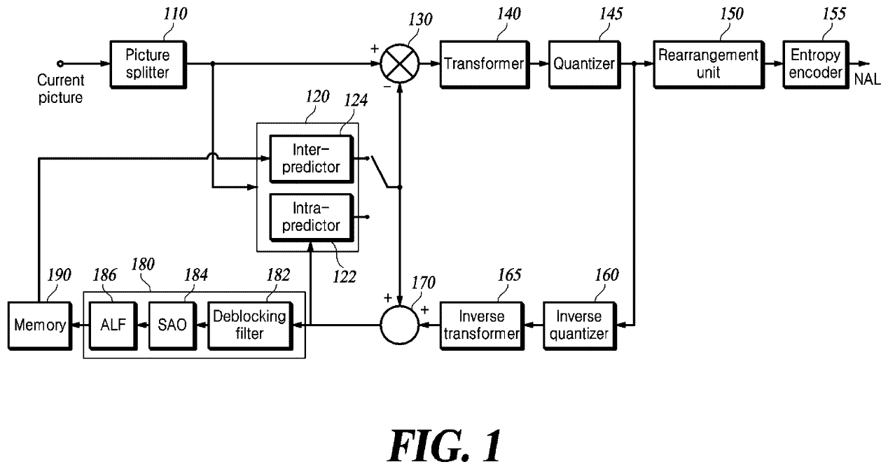

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group.

Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU).

Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

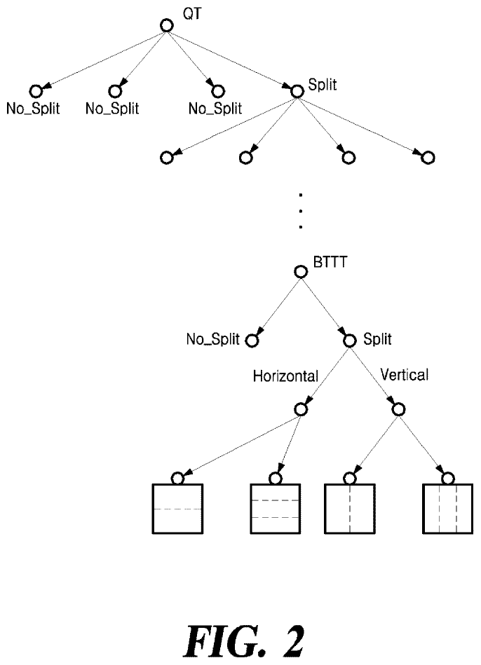

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded.

When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present.

The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

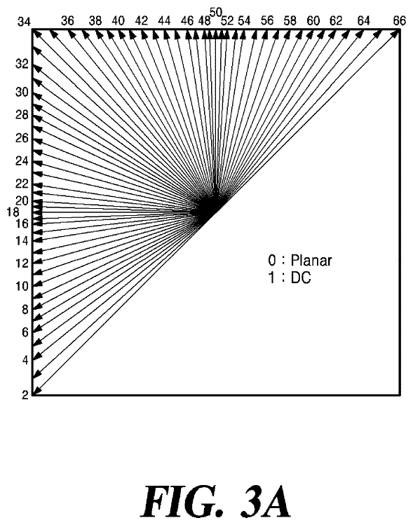

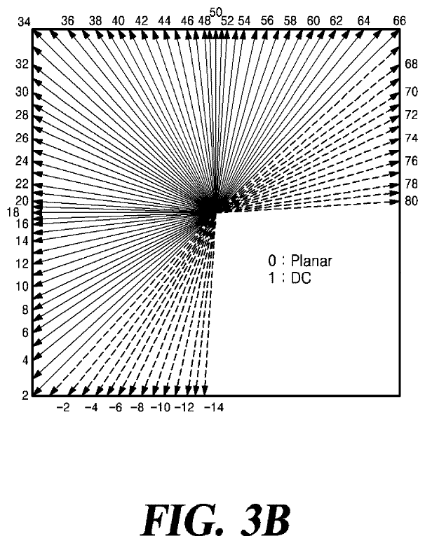

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”.

In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155.

Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

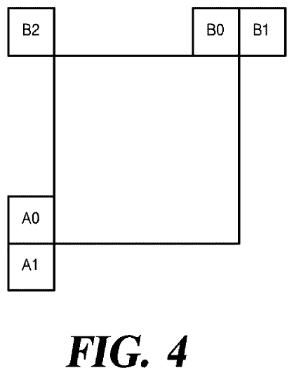

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks.

A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding apparatus may store a bitstream of encoded video data in a non-transitory storage medium or transmit the bitstream to the video decoding device through a communication network.

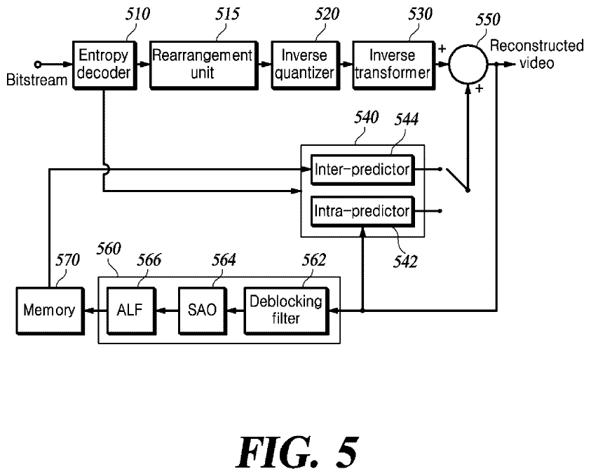

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510.

The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding.

The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The following embodiments may be performed by the intra predicting unit 122, the transforming unit 140, and the inverse transform unit 165 in the video encoding apparatus. They may also be performed by the inverse transform unit 530 and the intra predicting unit 542 in the video decoding apparatus. In the following, the video decoding apparatus is described as performing the respective process steps but the video encoding apparatus may also perform the same steps.

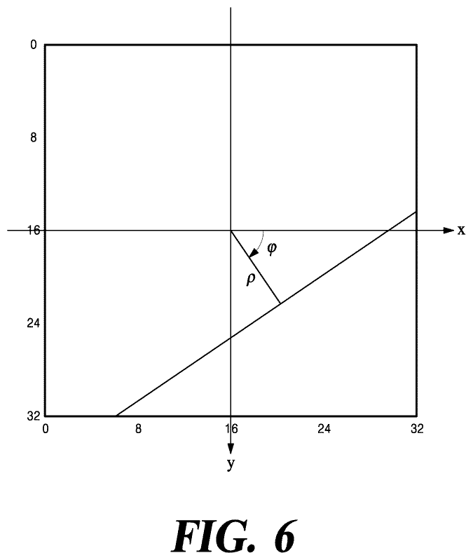

FIG. 6 is a diagram illustrating a method of applying a geometric partitioning mode to a 32×32 block, according to at least one embodiment of the present disclosure. As for the geometric partitioning mode, a coding unit is partitioned into two regions by a straight partitioning boundary. The two partitioned regions each perform inter prediction by using different motion information. An inter-prediction block is generated for each of the two partitioned regions. The final prediction block in the geometric partitioning mode is generated by weighted averaging the two inter-prediction blocks. The geometric partitioning mode uses an angular parameter and a distance parameter to set a partitioning boundary region defined by a straight line.

Referring to FIG. 6, a 32×32 block is partitioned into two regions. Inter prediction may be performed on each of the two partitioned regions. o may be an angular parameter. p may be a distance parameter. By using the angular parameter and the distance parameter, a straight line may be established that divides the 32×32 block.

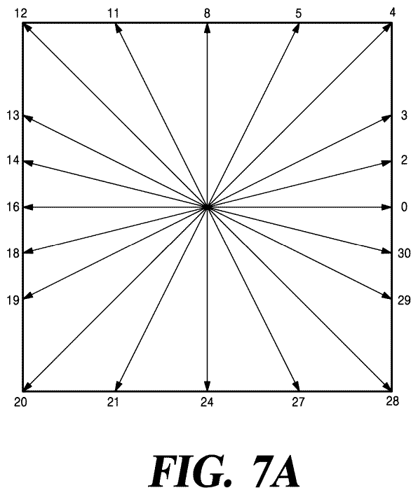

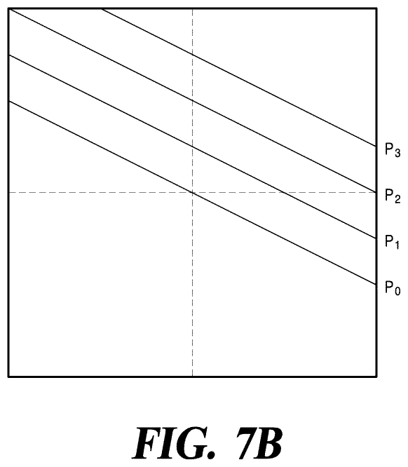

FIGS. 7A and 7B are diagrams illustrating angular parameters and distance parameters in a geometric partitioning mode, according to at least one embodiment of the present disclosure.

Referring to FIG. 7A, the angular parameter may be defined by a total of 20 quantized angles by symmetrically partitioning a 360-degree range within the coding unit.

Referring to FIG. 7B, the distance parameter may be defined by four quantized distances. From the total of 80 partitioning directions that may be generated by the combination of angular parameter and distance parameter, excluded may be 10 redundant partitioning directions and 6 partitioning directions that are redundant with binary tree partitioning and ternary tree partitioning. Thus, a total of 64 partitioning directions may be used in geometric partitioning mode.

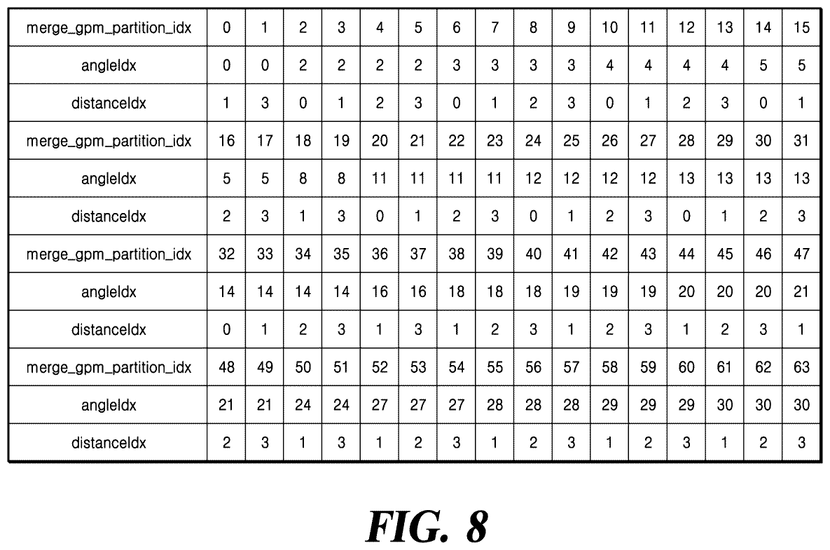

FIG. 8 is a diagram illustrating a look-up table of partitioning direction information in a geometric partitioning mode, according to at least one embodiment of the present disclosure. The combination of an angular parameter and a distance parameter may be represented by the look-up table. Partitioning direction information may be transmitted for each coding unit.

Geometric partitioning mode may configure from the regular merge candidate list a merge candidate list for the geometric partitioning mode, which includes only unidirectional motion information. This simplifies the encoding of motion information and reduces the number of possible combinations. By using the merge candidate list for the geometric partitioning mode, the merge index having been used for each partitioning region may be transmitted.

Referring to FIG. 8, according to information about an angular parameter (e.g., angleldx) and information about a distance parameter (e.g., distanceldx), partitioning direction information (e.g., merge_gpm_partition_idx) may be determined. The merge_gpm_partition_idx according to the combination of angleldx and distanceldx may be represented by the look-up table. The value of merge_gpm_partition_idx may be in the range 0 to 63. A merge_gpm_partition_idx may be transmitted for each coding unit.

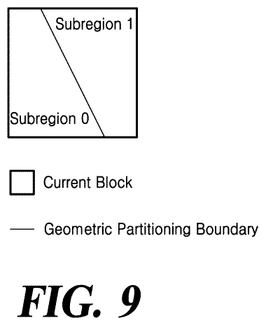

FIG. 9 is a diagram illustrating a geometric partitioning boundary and two subregions within the current block in a geometric partitioning mode, according to at least one embodiment of the present disclosure. Hereinafter, the video decoding apparatus is described as performing the respective processes, but the video encoding apparatus may also perform those processes.

Referring to FIG. 9, when the prediction mode of the current block is inter-prediction mode and the geometric partitioning mode, the video decoding apparatus partitions the current block into subregion 0 and subregion 1 by using a geometric partitioning boundary. The video decoding apparatus generates a prediction block in subregion 0 and a prediction block in subregion 1. The video decoding apparatus generates a final prediction block of the current block by using the prediction block of subregion 0 and the prediction block of subregion 1.

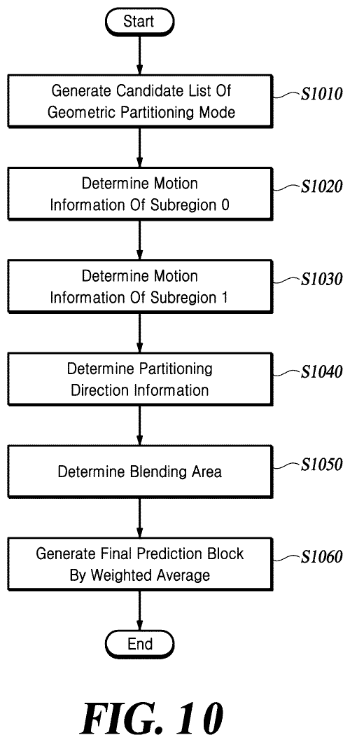

FIG. 10 is a flowchart of a process for generating a prediction block of the current block by using the geometric partitioning mode, according to at least one embodiment of the present disclosure.

Referring to FIG. 10, information (e.g., Derive_GPM_flag) indicative of whether a derivation-based geometric partitioning mode is to be performed may be parsed. When Derive_GPM_flag is a first value (e.g., 0), the video decoding apparatus may perform a regular geometric partitioning mode. If Derive_GPM_flag is a second value (e.g., 1), the video decoding apparatus may perform the derivation-based geometric partitioning mode. The derivation-based geometric partitioning mode is a mode of using the motion vector of subregion 0 to determine the motion vector of subregion 1 and using the motion vector of subregion 0 and the motion vector of subregion 1 to determine the partitioning direction information.

When Derive_GPM_flag is the second value (e.g., 1), the video decoding apparatus generates a candidate list of the geometric partitioning mode (S1010). The video decoding apparatus may determine a regular merge candidate list to be the candidate list of the geometric partitioning mode. The video decoding apparatus may use the regular merge candidate list to generate the candidate list of the geometric partitioning mode. The video decoding apparatus may generate the candidate list of the geometric partitioning mode by selecting the motion information present in the first reference picture list if the index of the regular merge candidate list is even, and selecting the motion information present in the second reference picture list if the index is odd.

The video decoding apparatus determines the motion information of subregion 0 (S1020). The video decoding apparatus may determine the motion information of subregion 0 by utilizing a parsed index (e.g., PM_idx_0) of the motion information of subregion 0. The video decoding apparatus may use PM_idx_0 to determine the motion information of subregion 0 from the candidate list of the geometric partitioning mode.

The video decoding apparatus determines the motion information of subregion 1 (S1030). The video decoding apparatus may determine the motion information of subregion 1 by using a parsed index (e.g., PM_idx_1) of the motion information of subregion 1 and the prediction block of subregion 0.

The video decoding apparatus determines the partitioning direction information (S1040). The video decoding apparatus may determine the partitioning direction information by using the motion information of subregion 1 and an index (e.g., GPMmode_idx) for the partitioning direction information.

The video decoding apparatus determines a blending area (S1050).

The video decoding apparatus may determine the blending area by using partitioning direction information, an index for the blending area (e.g., BlendingArea_idx), or the prediction block of subregion 0 and the prediction block of subregion 1. The video decoding apparatus generates a final prediction block of the current block by weighted averaging the prediction block of subregion 0 and the prediction block of subregion 1 (S1060). The video decoding apparatus may use the blending area to determine a blending matrix. By using the blending matrix, the video decoding apparatus may weight average the prediction block of subregion 0 and the prediction block of subregion 1 to generate the final prediction block of the current block.

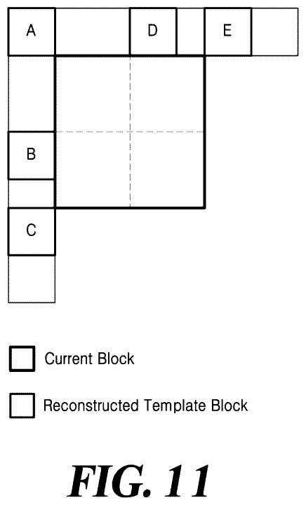

FIG. 11 is a diagram illustrating a current block and template blocks neighboring the current block, according to at least one embodiment of the present disclosure.

Referring to FIG. 11, the reconstructed template blocks neighboring the current block may be at the top, left, and top-left of the current block. The reconstructed template blocks neighboring the current block may be an A block, a B block, a C block, a D block, and an E block. The location and size of the reconstructed template blocks neighboring the current block may change based on the size and aspect ratio of the current block.

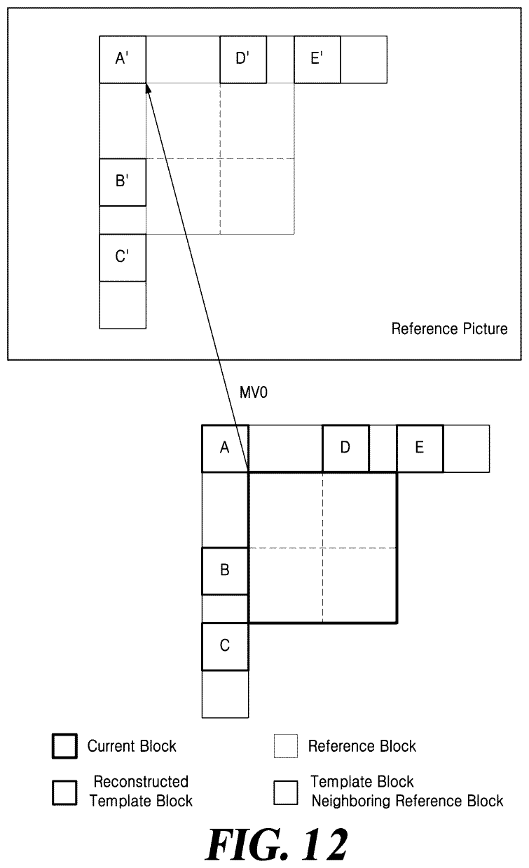

FIG. 12 is a diagram illustrating a method of performing template matching, according to at least one embodiment of the present disclosure.

Referring to FIG. 12, the video decoding apparatus may use PM_idx_0 to determine motion information of subregion 0 from the candidate list of the geometric partitioning mode. The motion information of subregion 0 includes the motion vector MVO of subregion 0. The video decoding apparatus may determine the reconstructed template blocks neighboring the current block to be A block, B block C block, D block, and E block. The video decoding apparatus may use the motion vector MVO to determine the template blocks as A′ block, B′ block C′ block, D′ block, and E′ block around the reference block in the reference picture.

The video decoding apparatus may perform template matching by using the A block, B block C block, D block, and E block, and the A′ block, B′ block C′ block, D block, and E′ block to determine the motion vector of subregion 1.

The video decoding apparatus may perform template matching in the order of the A block, B block C block, D block, and E block. However, the order of template matching may be varied without limitation. Template matching may be to find the block with the minimum error value of the loss function. The loss function may be, for example, a mean squared error (MSE) or a sum of absolute differences (SATD). The video decoding apparatus may calculate an error value of the loss function between the A block and A′ block, an error value of the loss function between the B block and B′ block, an error value of the loss function between the C block and C′ block, an error value of the loss function between the D block and D′ block, and an error value of the loss function between the E block and E′ block.

Of the A block, B block, C block, D block, and E block, the video decoding apparatus may select n blocks having the smallest error value of the loss function. The n blocks may be any predefined number of blocks. The number n may be determined based on the number of template blocks. The video decoding apparatus may utilize template blocks other than the selected n blocks to determine the motion vector of subregion 1. In another embodiment, the video decoding apparatus may perform template matching by selecting template blocks having an error value less than a predefined threshold.

The video decoding apparatus may determine the motion vector of subregion 1 by using the template blocks other than the matched template blocks and the motion vectors included in the candidate list of the geometric partitioning mode, except MVO which is the motion vector of subregion 0.

For example, of the A block, B block, C block, D block, and E block, those blocks selected by using template matching may be the A block, B block, and D block, and the candidate list of the geometric partitioning mode may include three motion vectors. Then, the video decoding apparatus may determine the motion vector of subregion 1 by using the C block and E block and two motion vectors from the motion vectors included in the candidate list of the geometric partitioning mode, except MVO. If the two motion vectors are MV′ and MV″, the video decoding apparatus may use the motion vector MV′ to determine reference block 1 in reference picture 1. The video decoding apparatus may determine a C″ block and an E″ block among template blocks to be template blocks corresponding to the C block and the E block, around reference block 1. The video decoding apparatus may use the motion vector MV″ to determine reference block 2 in reference picture 2. The video decoding apparatus may determine a C″ block and an E″ block among template blocks to be the template blocks corresponding to the C block and the E block, around reference block 2.

The video decoding apparatus may calculate K1 which is the sum of the error value of the loss function between the C and C″ blocks and an error value of the loss function between the E and E″ blocks and calculate K2 which is the sum of an error value of the loss function between the C and C″ blocks and an error value of the loss function between the E and E″ blocks. If K1 is less than K2, the video decoding apparatus may determine motion vector MV′ to be the motion vector of subregion 1. If K2 is less than K1, the video decoding apparatus may determine motion vector MV″ to be the motion vector of subregion 1.

The video decoding apparatus may determine the motion vector of subregion 1 by using the parsed PM_idx_1 and the template blocks other than the matched template block and the motion vectors included in the candidate list of the geometric partitioning mode, except MVO which is the motion vector of subregion 0. If m is the number of motion vectors included in the candidate list of the geometric partitioning mode, PM_idx_1 may be an integer value smaller than m.

For example, of the A block, B block, C block, D block, and E block, those blocks selected by using template matching may be the A block, B block, and D block, and the candidate list of the geometric partitioning mode may include three motion vectors. Then, the video decoding apparatus may determine the motion vector of subregion 1 by using the parsed PM_idx_1 and the C block and E block and two motion vectors from the motion vectors included in the candidate list of the geometric partitioning mode, except MVO.

If the two motion vectors are MV′ and MV″, the video decoding apparatus may use the motion vector MV′ to determine reference block 1 in reference picture 1. The video decoding apparatus may determine a C″ block and an E″ block among template blocks to be the template blocks corresponding to the C block and the E block, around reference block 1. The video decoding apparatus may use the motion vector MV″ to determine reference block 2 in reference picture 2. The video decoding apparatus may determine a C″ block and an E″ block among template blocks to be the template blocks corresponding to the C block and the E block, around reference block 2.

The video decoding apparatus may calculate K1 which is the sum of the error value of the loss function between the C and C″ blocks and an error value of the loss function between the E and E″ blocks and calculate K2 which is the sum of an error value of the loss function between the C and C″ blocks and an error value of the loss function between the E and E″ blocks. If K1 is less than K2, the video decoding apparatus may arrange the motion vector candidates in the order of MV′ and MV″. The video decoding apparatus may use the parsed PM_idx_1 to determine the motion vector of subregion 1 between the arranged motion vector candidates. If K2 is less than K1, the video decoding apparatus may arrange the motion vector candidates in the order of MV″ and MV′. The video decoding apparatus may use the parsed PM_idx_1 to determine the motion vector of subregion 1 between the arranged motion vector candidates.

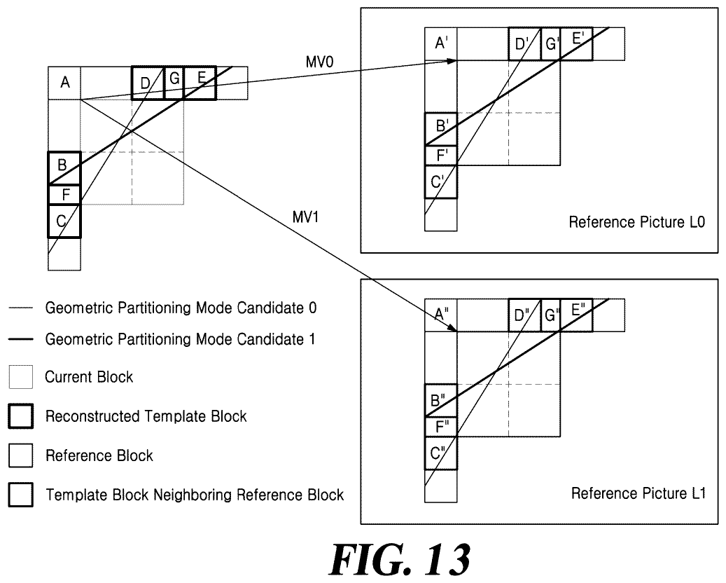

FIG. 13 is a diagram illustrating a method of determining partitioning direction information by performing template matching, according to at least one embodiment of the present disclosure.

Referring to FIG. 13, the video decoding apparatus may determine the reconstructed template blocks neighboring the current block as A block, B block C block, D block, and E block. The video decoding apparatus may use the motion vector MV0 of subregion 0 to determine the template blocks as A′ block, B′ block, C′ block, D′ block, and E′ block, around the reference block in the reference picture LO.

Where A block, B block, and D block have been matched by performing the template matching described in FIG. 12, the video decoding apparatus may use C block and E block to determine the current block's partitioning direction candidates from the 64-partitioning direction information. The video decoding apparatus determines the partitioning direction candidates by utilizing the geometric partitioning boundaries passing from between B and C blocks to between D and E blocks. For example, if there are three geometric partitioning boundaries passing from between B and C blocks to between D and E blocks among the 64 geometric partitioning boundaries, the video decoding apparatus may determine three partitioning direction candidates from the 64-partitioning direction information.

The video decoding apparatus determines the current block's partitioning direction information among the partitioning direction candidates by using a weighted sum signal of the template blocks in the reference picture.

The weighted sum signal P_{G}(i, j) of the template blocks for the partitioning direction candidates may be expressed as shown in Equation 1.

P_{G}(i, j)=(W_{B}(i, j)×P₀+(2^{k}−W_{B}(i, j)×P₁+(2^{k-1})»k Equation 1

Here, W_{B} is a geometric matrix of partitioning direction candidates.

The value of each coefficient of W_{B} may range from 0 to 2k integer values.

Here, k is an integer. k may be any predefined positive integer value. To the respective partitioning direction candidates, a predefined W_{B} may be applied.

Po may be a signal for a region in the reference picture L0, which contains B′ block, F′ block, C′ block, D′ block, G′ block, and E′ block that are the template blocks of the reference block. There is an F block between B and C blocks, and a G block between D and E blocks. B′ block, F′ block, C′ block, D′ block, G′ block, and E′ block correspond to B block, F block, C block, D block, G block, and E block and are the template blocks in reference picture LO.

P₁ may be a signal for a region in the reference picture L1, which contains B″ block, F″ block, C″ block, D″ block, G″ block, and E″ block that are the template blocks of the reference block. B″ block, F″ block, C″ block, D″ block, G″ block, and E″ block correspond to B block, F block, C block, D block, G block, and E block and are the template blocks in reference picture L1. The video decoding apparatus may calculate P_{G}(i, j) for each partitioning direction candidate. For example, if among the 64 geometric partitioning boundaries, three geometric partitioning boundaries pass from between B and C blocks to between D and E blocks, the video decoding apparatus may determine three partitioning direction candidates. The video decoding apparatus may calculate P_{G}(i, j) for each of the three partitioning direction candidates by using Equation 1, W_{B}, P₀, and P₁.

The video decoding apparatus may calculate an error value of a loss function between the weighted sum signal P_{G}(i, j) for each of the three partitioning direction candidates and a region containing B block, F block, C block, D block, G block, and E block within the region containing the template blocks of the current block. The loss function may be MSE, SATD, or the like. For example, if the three determined partitioning direction candidates are direction information 1, direction information 2, and direction information 3, the video decoding apparatus may calculate P_{G1}(i, j) for direction information 1, P_{G2}(i, j) for direction information 2, and P_{G3}(i, j) for direction information 3.

The video decoding apparatus may calculate an error value E1 of the loss function between P_{G1}(i, j) and the region containing B block, F block, C block, D block, G block, and E block. It may calculate an error value E2 of the loss function between P_{G2}(i, j) and the region containing B block, F block, C block, D block, G block, and E block. It may calculate an error value E3 of the loss function between P_{G3}(i, j) and the region containing B block, F block, C block, D block, G block, and E block. If the value of E1 is the smallest among the calculated error values E1, E2, and E3, the video decoding apparatus may determine that the partitioning direction information of the current block is direction information 1. If the value of E2 is the smallest among the calculated error values E1, E2, and E3, the video decoding apparatus may determine that the partitioning direction information of the current block is direction information 2. If the value of E3 is the smallest among the calculated error values E1, E2, and E3, the video decoding apparatus may determine that the partitioning direction information of the current block is direction information 3.

The video decoding apparatus may determine the partitioning direction information of the current block by using P_{G}(i, j) for each of the partitioning direction candidates and the region containing the B block, F block, C block, D block, G block, and E block, and the parsed GPMmode_idx. The value of GPMmode_idx may be an integer value less than the number of partitioning direction candidates.

For example, if the three determined partitioning direction candidates are direction information 1, direction information 2, and direction information 3, the video decoding apparatus may calculate P_{G1}(i, j) for direction information 1, P_{G2}(i, j) for direction information 2, and P_{G3}(i, j) for direction information 3. The video decoding apparatus may calculate the error value E1 of the loss function between P_{G1}(i, j) and the region containing the B block, F block, C block, D block, G block, and E block, and calculate the error value E2 of the loss function between P_{G2}(i, j) and the region containing the B block, F block, C block, D block, G block, and E block, and calculate the error value E3 of the loss function between P_{G3}(i, j) and the region containing the B block, F block, C block, D block, G block, and E block. The video decoding apparatus may rearrange the partitioning direction candidates in order of decreasing error value thereof. If E1, E3, and E2 are in order of decreasing error value, the video decoding apparatus may reorder the partitioning direction candidates to be arranged as direction information 1, direction information 3, and direction information 2.

The video decoding apparatus may use the parsed GPMmode_idx and the reordered partitioning direction candidates to determine the partitioning direction information of the current block.

### Determining Blending Area

The video decoding apparatus utilizes the determined partitioning direction information of the current block and the motion information of subregion 0 and the motion information of subregion 1, to generate a prediction block of subregion 0 and a prediction block of subregion 1. The video decoding apparatus determines a blending area by using the partitioning direction information among others. The video decoding apparatus uses the blending area to determine a blending matrix, W_{B}^{f}(i, j), to be used in the process of weight-averaging the prediction block of subregion 0 and the prediction block of subregion 1.

For example, the video decoding apparatus may use the size of the current block and the partitioning direction information of the current block to determine a blending area. Here, the blending area may be a region predefined based on the size of the current block and the partitioning direction information of the current block. For example, the video decoding apparatus may use the parsed BlendingArea_idx to determine the blending area. For example, the video decoding apparatus may determine the blending area by using the initial prediction signals around a geometric partitioning boundary of the current block.

The video decoding apparatus may use the determined blending area to determine a blending matrix, W_{B}^{f}(i, j). The blending matrix may be a matrix predefined based on the blending area. The value of each coefficient in W_{B}^{f}(i, j) may range from 0 to 2^{w} integer values. Here, w may be determined based on the size of the current block and/or the partitioning direction information of the current block. Here, w may be an integer value.

### Performing Weighted Averaging

The video decoding apparatus uses the prediction block of subregion 0, the prediction block of subregion 1, and the blending matrix, W_{B}^{f}(i, j) to generate a final prediction block of the current block. The final prediction block, P_{K}(i, j) of the current block may be expressed as Equation 2.

P_{K}(i, j)=(W_{B}^{f}(i, j)×P₀+(2^{w}−W_{B}^{f}(i, j)×P₁+(2^{w-1})»w Equation 2

Here, P₀ may be the prediction block by using the motion vector of subregion 0, and P₁ may be the prediction block by using the motion vector of subregion 1. W_{B}^{f}(i, j) is a blending matrix determined from the blending area. W may be an arbitrary predefined value.

### Final Prediction block of Chroma Block

When the video decoding apparatus generates the final prediction block of the chroma block, the video decoding apparatus may generate the final prediction block of the chroma block by sampling a blending area of the luma block at a corresponding position based on the color format. In another embodiment, the video decoding apparatus may sample motion information, partitioning direction information, or the blending area of the luma block based on the color format to generate the final prediction block of the chroma block.

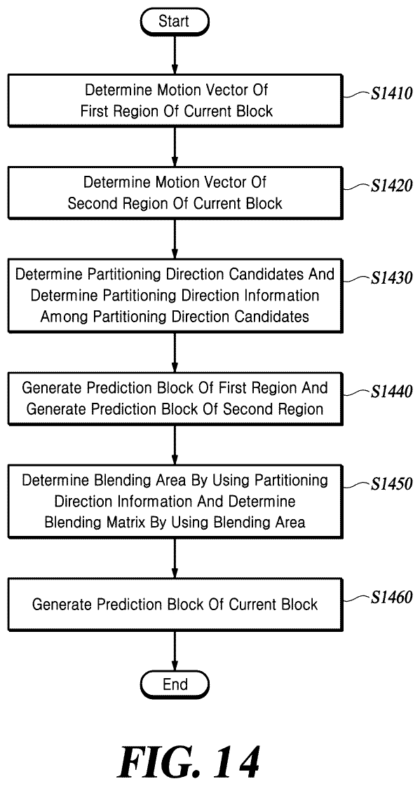

FIG. 14 is a flowchart of a video decoding process according to at least one embodiment of the present disclosure.

Referring to FIG. 14, the video decoding apparatus determines a motion vector of a first region of the current block by using the merge candidate list (S1410). The process of determining the motion vector of the first region includes determining a candidate list of the geometric partitioning mode by using an index of the merge candidate list, and determining the motion vector of the first region by using the candidate list of the geometric partitioning mode.

The video decoding apparatus determines a motion vector of a second region of the current block by using the motion vector of the first region and the template blocks of the current block (S1420). The process of determining the motion vector of the second region includes determining the template blocks of a reference block in a first reference picture by using the motion vector of the first region, calculating the first error values of a loss function between the template blocks of the current block and the template blocks of the reference block, and determining a block that is not template matched by using the first error values.

The process of determining the motion vector of the second region further includes determining the template blocks that are positioned in the reference pictures and correspond to the non-template-matched blocks by using the motion vectors among the motion vectors included in the candidate list of the geometric partitioning mode, excluding the motion vector of the first region, calculating second error values of the loss function between the non-template-matched blocks and the template blocks in the reference pictures, and determining the motion vector of the second region by using the second error values.

The video decoding apparatus determines partitioning direction candidates by using the template blocks of the current block and determines partitioning direction information among the partitioning direction candidates (S1430). The process of determining the partitioning direction information includes determining a third region containing the template blocks positioned in the first reference picture and corresponding to the non-template-matched blocks and determining a fourth region containing the template blocks positioned in the second reference picture and corresponding to the non-template-matched blocks by using the motion vector of the second region.

The process of determining the partitioning direction information further includes calculating weighted sum signals for the partitioning direction candidates by applying the third region, the fourth region, and the geometric matrices to the first equation 1, calculating a third error value of the loss function between the weighted sum signals and the region including the template blocks of the current block, and determining the partitioning direction information by using the third error value. The geometric matrices may be matrices predefined based on the partitioning direction candidates.

The video decoding apparatus generates a prediction block of the first region by using the motion vector of the first region and generates a prediction block of the second region by using the motion vector of the second region (S1440). The video decoding apparatus determines a blending area by using the partitioning direction information and determines a blending matrix by using the blending area (S1450). The video decoding apparatus generates a prediction block of the current block by using the blending matrix, the prediction block of the first region, and the prediction block of the second region (S1460). The process of generating the prediction block of the current block includes applying the blending matrix, the prediction block of the first region, and the prediction block of the second region to the second equation 2 to generate the prediction block of the current block. The blending matrix may be a matrix predefined based on the blending area.

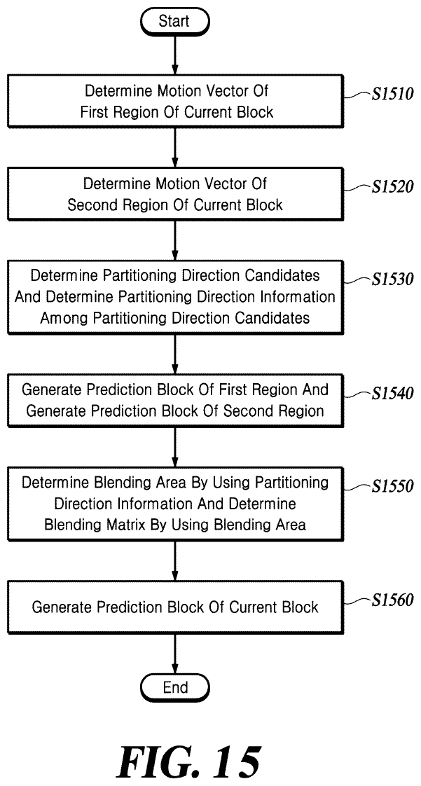

FIG. 15 is a flowchart of a video encoding process according to at least one embodiment of the present disclosure.

Referring to FIG. 15, the video encoding apparatus determines a motion vector of a first region of the current block by using the merge candidate list (S1510). The process of determining the motion vector of the first region includes determining a candidate list of the geometric partitioning mode by using an index of the merge candidate list, and determining the motion vector of the first region by using the candidate list of the geometric partitioning mode.

The video encoding apparatus determines a motion vector of a second region of the current block by using the motion vector of the first region and the template blocks of the current block (S1520). The process of determining the motion vector of the second region includes determining the template blocks of a reference block in a first reference picture by using the motion vector of the first region, calculating a first error value of the loss function between the template blocks of the current block and the template blocks of the reference block, and determining non-template-matched blocks by using the first error value.

The process of determining the motion vector of the second region further includes determining the template blocks positioned in the reference picture and correspond to the non-template-matched blocks by using the motion vectors among the motion vectors included in the candidate list of the geometric partitioning mode, excluding the motion vector of the first region, calculating a second error value of the loss function between the non-template-matched blocks and the template blocks in the reference pictures, and determining the motion vector of the second region by using the second error value.

The video encoding apparatus determines partitioning direction candidates by using the template blocks of the current block and determines partitioning direction information among the partitioning direction candidates (S1530). The process of determining the partitioning direction information includes determining a third region containing the template blocks positioned in the first reference picture and corresponding to the non-template-matched blocks, and determining a fourth region containing the template blocks positioned in the second reference picture and corresponding to the non-template-matched blocks by using the motion vector of the second region.

The process of determining the partitioning direction information further includes calculating weighted sum signals for the partitioning direction candidates by applying the third region, the fourth region, and the geometric matrices to the first equation 1, calculating a third error value of the loss function between the weighted sum signals and the region including the template blocks of the current block, and determining the partitioning direction information by using the third error value. The geometric matrices may be matrices predefined based on the partitioning direction candidates.

The video encoding apparatus generates a prediction block of the first region by using the motion vector of the first region and generates a prediction block of the second region by using the motion vector of the second region (S1540). The video encoding apparatus determines a blending area by using the partitioning direction information and determines a blending matrix by using the blending area (S1550). The video encoding apparatus generates a prediction block of the current block by using the blending matrix, the prediction block of the first region, and the prediction block of the second region (S1560). The process of generating the prediction block of the current block includes applying the blending matrix, the prediction block of the first region, and the prediction block of the second region to the second equation 2 to generate the prediction block of the current block. The blending matrix may be a matrix predefined based on the blending area.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors.

The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### CROSS-REFERENCE TO RELATED APPLICATION

This application claims priority from Korean Patent Application No. 10-2022-0168738 filed on Dec. 6, 2022, and Korean Patent Application No. 10-2023-0172358 filed on Dec. 1, 2023, the disclosures of which are incorporated by reference herein in their entirety.

What is claimed is:

1. A video decoding method, comprising:
determining a motion vector of a first region of a current block by using a merge candidate list;
determining a motion vector of a second region of the current block by using the motion vector of the first region and template blocks of the current block;
determining partitioning direction candidates by using the template blocks of the current block, and determining partitioning direction information of the current block among the partitioning direction candidates;
generating a prediction block of the first region by using the motion vector of the first region, and generating a prediction block of the second region by using the motion vector of the second region;
determining a blending area by using the partitioning direction information, and determining a blending matrix by using the blending area; and
generating a prediction block of the current block by using the blending matrix, the prediction block of the first region, and the prediction block of the second region.

2. The method of claim 1, wherein determining the motion vector of the first region comprises:
determining a candidate list of a geometric partitioning mode by using an index of the merge candidate list; and
determining the motion vector of the first region by using the candidate list of the geometric partitioning mode.

3. The method of claim 2, wherein determining the motion vector of the second region comprises:
determining template blocks of a reference block in a first reference picture by using the motion vector of the first region;
calculating first error values of a loss function between the template blocks of the current block and the template blocks of the reference block; and
determining non-template-matched blocks by using the first error values.

4. The method of claim 3, wherein determining the motion vector of the second region further comprises:
determining template blocks that are in reference pictures and correspond to the non-template-matched blocks by using motion vectors included in the candidate list of the geometric partitioning mode, excluding the motion vector of the first region;
calculating second error values of a loss function between the non-template-matched blocks and the template blocks that are in the reference pictures and correspond to the non-template-matched blocks; and
determining the motion vector of the second region by using the second error values.

5. The method of claim 4, wherein determining the partitioning direction information comprises:
determining a third region containing template blocks that are in the first reference picture and correspond to the non-template-matched blocks; and
determining, by using the motion vector of the second region, a fourth region containing template blocks that are in a second reference picture and correspond to the non-template-matched blocks.

6. The method of claim 5, wherein determining the partitioning direction information comprises:
calculating weighted sum signals for the partitioning direction candidates by applying, to a first equation, the third region, the fourth region, and geometric matrices that are predefined based on the partitioning direction candidates;
calculating third error values of a loss function between the weighted sum signals and a region containing the template blocks of the current block; and
determining the partitioning direction information by using the third error values.

7. The method of claim 1, wherein generating the prediction block of the current block comprises:
generating the prediction block of the current block by applying the blending matrix, the prediction block of the first region, and the prediction block of the second region to a second equation,
wherein the blending matrix is predefined based on the blending area.

8. A video encoding method, comprising:
determining a motion vector of a first region of a current block by using a merge candidate list;
determining a motion vector of a second region of the current block by using the motion vector of the first region and template blocks of the current block;
determining partitioning direction candidates by using the template blocks of the current block, and determining partitioning direction information of the current block among the partitioning direction candidates;
generating a prediction block of the first region by using the motion vector of the first region, and generating a prediction block of the second region by using the motion vector of the second region;
determining a blending area by using the partitioning direction information, and determining a blending matrix by using the blending area; and
generating a prediction block of the current block by using the blending matrix, the prediction block of the first region, and the prediction block of the second region.

9. The method of claim 8, wherein determining the motion vector of the first region comprises:
determining a candidate list of a geometric partitioning mode by using an index of the merge candidate list; and
determining the motion vector of the first region by using the candidate list of the geometric partitioning mode.

10. The method of claim 9, wherein determining the motion vector of the second region comprises:
determining template blocks of a reference block in a first reference picture by using the motion vector of the first region;
calculating first error values of a loss function between the template blocks of the current block and the template blocks of the reference block; and
determining non-template-matched blocks by using the first error values.

11. The method of claim 10, wherein determining the motion vector of the second region further comprises:
determining template blocks that are in reference pictures and correspond to the non-template-matched blocks by using motion vectors included in the candidate list of the geometric partitioning mode, excluding the motion vector of the first region;
calculating second error values of a loss function between the non-template-matched blocks and the template blocks that are in the reference pictures and correspond to the non-template-matched blocks; and
determining the motion vector of the second region by using the second error values.

12. The method of claim 11, wherein determining the partitioning direction information comprises:
determining a third region containing template blocks that are in the first reference picture and correspond to the non-template-matched blocks; and
determining, by using the motion vector of the second region, a fourth region containing template blocks that are in a second reference picture and correspond to the non-template-matched blocks.

13. The method of claim 12, wherein determining the partitioning direction information comprises:
calculating weighted sum signals for the partitioning direction candidates by applying, to a first equation, the third region, the fourth region, and geometric matrices that are predefined based on the partitioning direction candidates;
calculating third error values of a loss function between the weighted sum signals and a region containing the template blocks of the current block; and
determining the partitioning direction information by using the third error values.

14. The method of claim 8, wherein generating the prediction block of the current block comprises:
generating the prediction block of the current block by applying the blending matrix, the prediction block of the first region, and the prediction block of the second region to a second equation, wherein the blending matrix is predefined based on the blending area.

15. A non-transitory computer-readable recording medium configured to store a bitstream generated by a video encoding method, the method comprising:
determining a motion vector of a first region of a current block by using a merge candidate list;
determining a motion vector of a second region of the current block by using the motion vector of the first region and template blocks of the current block;
determining partitioning direction candidates by using the template blocks of the current block, and determining partitioning direction information of the current block among the partitioning direction candidates;
generating a prediction block of the first region by using the motion vector of the first region, and generating a prediction block of the second region by using the motion vector of the second region;
determining a blending area by using the partitioning direction information, and determining a blending matrix by using the blending area; and
generating a prediction block of the current block by using the blending matrix, the prediction block of the first region, and the prediction block of the second region.
